(19) United States
(12) Patent Application Publication
(10) Pub. No.: US 2008/0174499 A1
(43) Pub. Date: Jul. 24, 2008

(54) Dipole antenna and electronic apparatus using the same

(75) Inventors: Saou-Wen Su, Taipei (TW); Ter-Ming Tang, Taipei (TW); Horng-Ming Tai, Taipei (TW)

Correspondence Address: BACON & THOMAS, PLLC, 625 SLATERS LANE, FOURTH FLOOR, ALEXANDRIA, VA, 22314, US

(73) Assignee: LITE-ON TECHNOLOGY CORPORATION, Taipei (TW)

(21) Appl. No.: 12/003,693

(22) Filed: Dec. 31, 2007

(30) Foreign Application Priority Data
Jan. 18, 2007 (TW) 96101964

(51) Int. Cl. H01Q 9/16; H01Q 1/24

(52) U.S. Cl. 343/702; 343/795

(57) ABSTRACT

A dipole antenna includes a substrate, a radiating metal plate and a radiating metal line. The radiating metal plate is disposed on the substrate and has a first signal feeding point near a lateral side of the substrate. The radiating metal line has a second signal feeding point near the first signal feeding point.

This application claims the benefit of Taiwan application Serial No. 96101964, filed Jan. 18, 2007, the subject matter of which is incorporated herein by reference.

### BACKGROUND OF THE INVENTION

1. Field of the Invention

The invention in general relates to an antenna, and more particularly to a dipole antenna and an electronic apparatus using the same.

2. Description of the Related Art

With the passed legislation for restricting the import of the build-in digital-television tuner in various main countries in the world and the mandate to stop using analog television, the digital television tends to replace the analog television in the development of the current television industry. Different telecommunication systems and different digital television standards are used in different countries. Three standards, including the DVB-T (Digital Video Broadcasting-Terrestrial) specification in Europe, the ATSC (Advanced Television Systems Committee) specification in the United States, and the ISDB-T (Integrated Services Digital Broadcasting-Terrestrial) specification in Japan, are used in the world. In Taiwan, the DVB-T specification is mainly adopted.

However, the digital television receiving apparatus (i.e., the television box that is frequently seen) is coupled to an external monopole or dipole antenna through an additional coaxial cable, which has a length ranging from about 100 to 150 cm, cannot be carried conveniently, and has the high cost. Alternatively, a television box having a build-in antenna can be found so that the cost of the television box can be decreased as compared with that for separately manufacturing the television box and the antenna. However, the overall dimension of the television box and the signal receiving quality of the antenna cannot be effectively optimized.

### SUMMARY OF THE INVENTION

The invention is directed to a dipole antenna and an electronic apparatus using the same. The dipole antenna and a system circuit of the electronic apparatus (e.g., a digital television receiving apparatus or various plug-and-play apparatuses) may be effectively integrated together according to different dimensions of two metal arms of the antenna so that the manufacturing cost and the dimension of the apparatus may be reduced. Thus, the antenna has a simple structure and can easily be manufactured. In addition, by definition of 2.5:1 VSWR (Voltage Standing Wave Ratio), the impedance bandwidth can also cover the digital television channels (530 to 602 MHz) in Taiwan and thus satisfies the requirement in the industry.

According to a first aspect of the present invention, a dipole antenna including a substrate, a radiating metal plate and a radiating metal line is provided. The radiating metal plate is disposed on the substrate and has a first signal feeding point, which is near a lateral side of the substrate. The radiating metal line has a second signal feeding point near the first signal feeding point.

According to a second aspect of the present invention, an electronic apparatus including a casing, a dipole antenna and a control circuit is provided. The dipole antenna includes a substrate, a radiating metal plate and a radiating metal line. The substrate is disposed in the casing. The radiating metal plate is disposed on the substrate and has a first signal feeding point, which is near a lateral side of the substrate. The radiating metal line has a second signal feeding point near the first signal feeding point. The control circuit is disposed in the casing and coupled to the dipole antenna.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a dipole antenna according to a preferred embodiment of the invention.

FIG. 2 is a schematic illustration showing an electronic apparatus using the dipole antenna 100 according to the preferred embodiment of the invention.

FIG. 3 shows a measured return loss of the dipole antenna 100.

FIG. 4 shows a radiation pattern of the dipole antenna 100 at 560 MHz.

FIG. 5 shows an antenna gain of the dipole antenna 100.

FIGS. 6A and 7B are two schematic illustrations showing dipole antennas according to other embodiments of the invention.

### DETAILED DESCRIPTION OF THE INVENTION

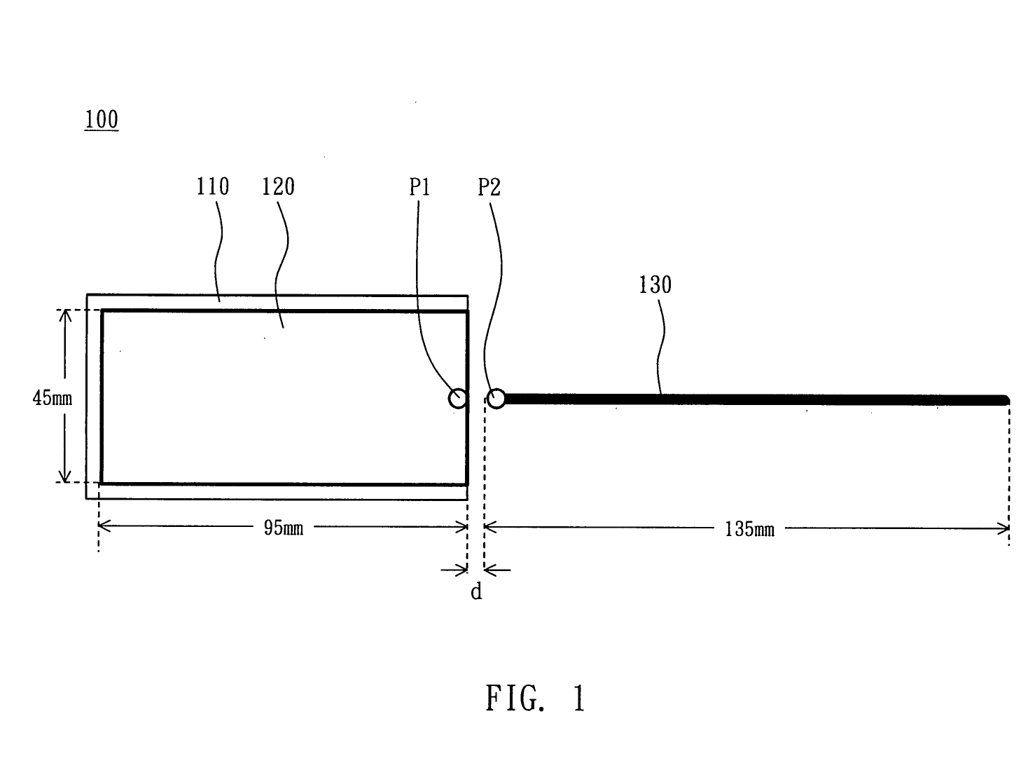

FIG. 1 is a schematic illustration showing a dipole antenna 100 according to a preferred embodiment of the invention. Referring to FIG. 1, the dipole antenna 100 includes a substrate 110, a radiating metal plate 120 and a radiating metal line 130. For example, the substrate 110 is a multi-layer printed circuit board (PCB), and the radiating metal plate 120 is formed on the substrate 110 by way of etching or printing and has a first signal feeding point P1, which is near a lateral side of the substrate 110. The shape of the radiating metal plate 120 may be changed according to the actual application. For example, the radiating metal plate 120 may have a polygonal shape or an elliptic shape. In this embodiment, the radiating metal plate 120 has a rectangular shape, and a width and a length of the radiating metal plate 120 are respectively 45 mm and 95 mm, as shown in FIG. 1.

The radiating metal line 130 has a second signal feeding point P2. The gap d between the signal feeding points P1 and P2 is preferably smaller than 3 mm. In this embodiment, the length of the radiating metal line 130 is about 135 mm. In addition, the radiating metal line 130 and the radiating metal plate 120 may be made of different materials have a single core or multiple cores to obtain the suitable flexibility. In other embodiments, the dimensions of the radiating metal plate 120 and the radiating metal line 130 may be designed according to the dimension of the electronic apparatus, such as that of the DVB-T USD dongle.

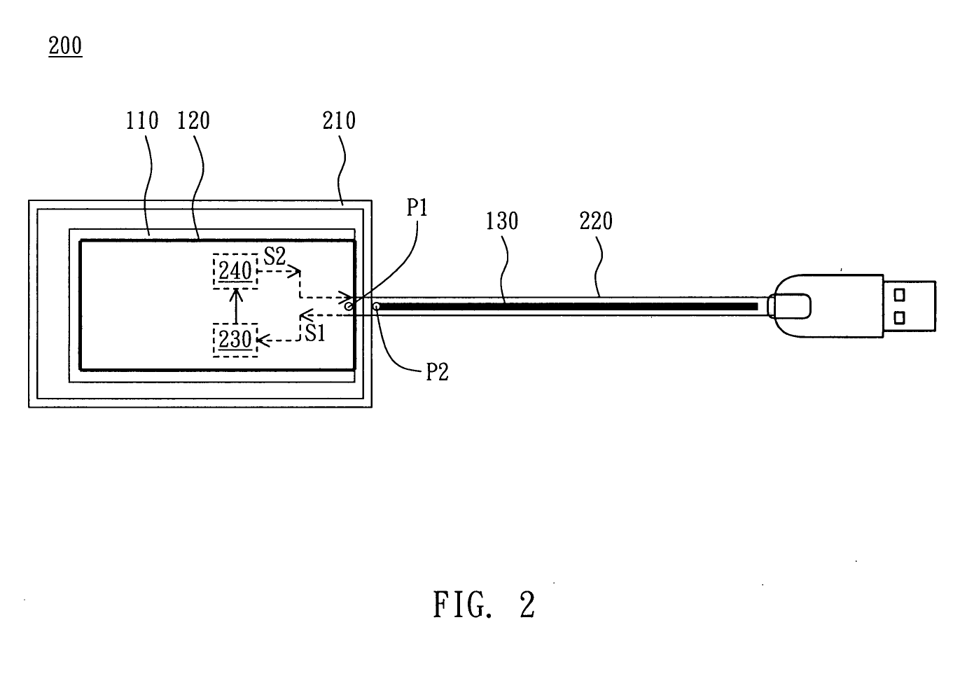

FIG. 2 is a schematic illustration showing an electronic apparatus 200 using the dipole antenna 100 according to the preferred embodiment of the invention. Referring to FIG. 2, the electronic apparatus 200 includes the dipole antenna 100, a casing 210, a transmission cable 220, a control circuit 230 and a transmission interface 240. In this embodiment, the electronic apparatus 200 is a digital television receiving apparatus, and the control circuit 230 includes a digital television tuner supporting the DVB-T specification. The transmission interface 240 is a universal serial bus (USB) interface, for example, and has a USB hub, and the transmission cable 220 is a USB transmission cable.

As shown in FIG. 2, the transmission cable 220 has one end, which is coupled to the casing 210 and thus electrically connected to the substrate 110 in the casing 210, and the other end, which is a USB plug to be connected to a television or a computer (not shown). In this embodiment, the radiating metal line 130 is disposed in the transmission cable 220 and the two neighboring signal feeding points P1 and P2 are substantially disposed at a coupling portion between the casing 210 and the transmission cable 220. The control circuit 230 and the transmission interface 240 are disposed in the substrate 110 and electrically connected to each other. The radiating metal plate 120 serves as a ground plane of the electronic apparatus 200.

In addition, the digital television tuner in the control circuit 230 is coupled to the two signal feeding points P1 and P2 of the dipole antenna 100 according to the manufacturing processes and the structure of the substrate 110 and the transmission cable 220. Consequently, after the dipole antenna 100 receives a digital television signal S1, the digital television tuner of the control circuit 230 can acquire the digital television signal S1 from the two signal feeding points P1 and P2 so that the associated demodulating or modulating process can be performed. Then, the processed image signal S2 is transmitted to the television or the computer through the transmission interface 240 and the transmission cable 220, and the television or the computer may display the digital image according to the processed image signal S2 for the user.

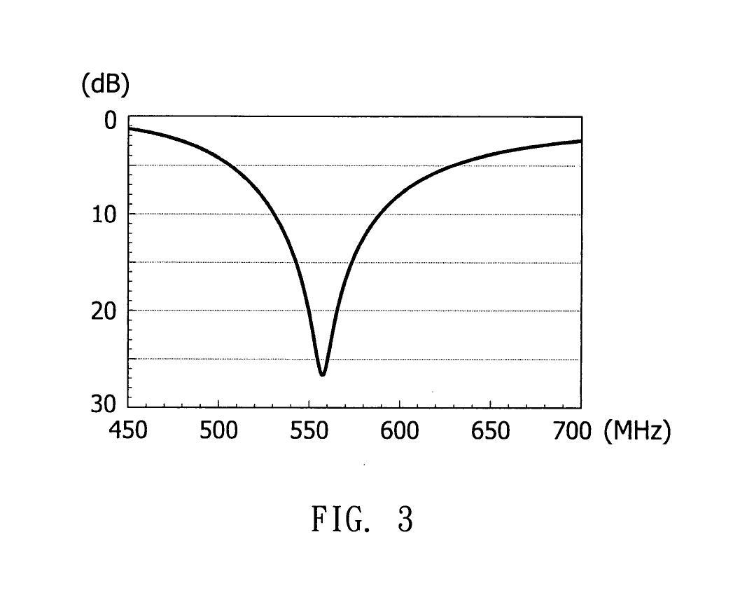

FIG. 3 shows a measured return loss of the dipole antenna 100. In FIG. 3, the vertical axis represents the value of the return loss of the antenna, and the horizontal axis represents the operating frequency of the antenna. It is observed, from the measured results of the return loss, that the dipole antenna 100 having the above-mentioned dimension and design has the operating bandwidth covering the band ranging from about 530 to 602 MHz by definition of 2.5:1 VSWR (Voltage Standing Wave Ratio) (about 7.3 dB return loss). The return loss level can satisfy the requirement of the actual application of digital television signal receiving performance.

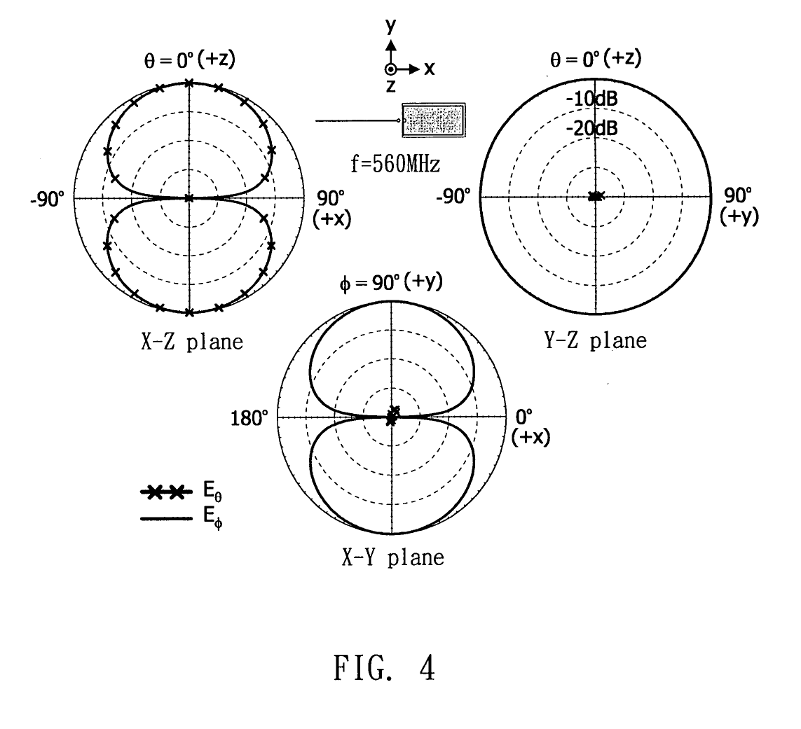

FIG. 4 shows the radiation pattern of the dipole antenna 100 at 560 MHz. As shown in FIG. 4, the dipole antenna 100 can provide omnidirectional radiation pattern for digital television signal receiving.

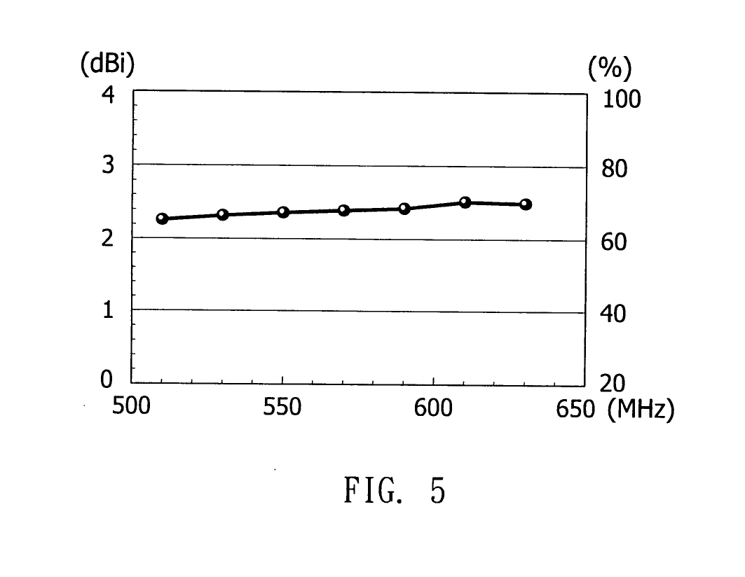

FIG. 5 shows an antenna gain of the dipole antenna 100. In FIG. 5, the vertical axis represents the antenna gain, and the horizontal axis represents the operating frequency of the antenna. As shown in FIG. 5, the antenna gain between 530 and 602 MHz ranges from about 2 to 3 dBi and is much better than the required antenna gain for digital television applications.

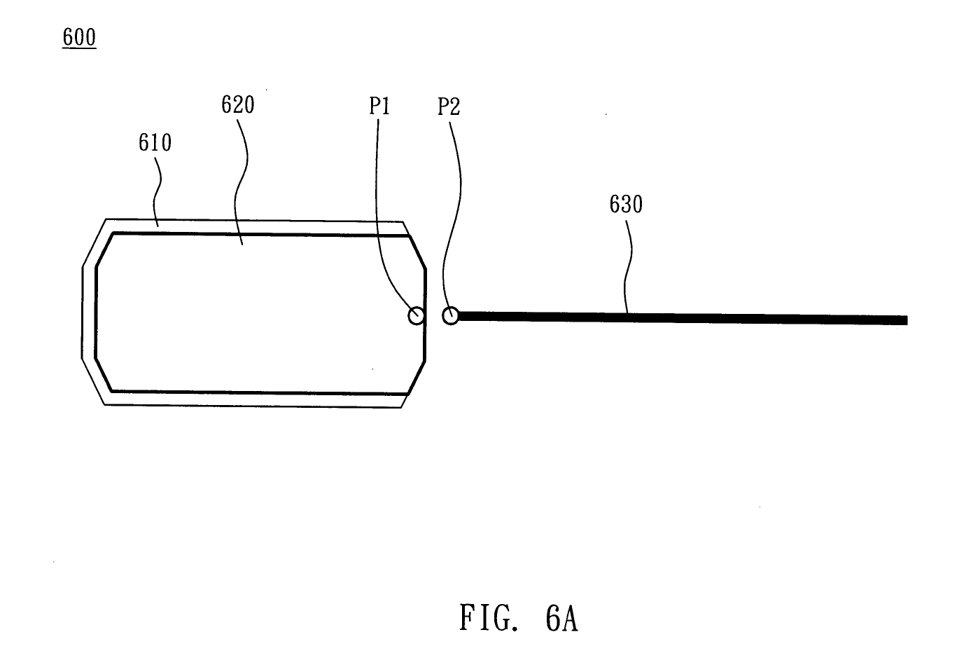

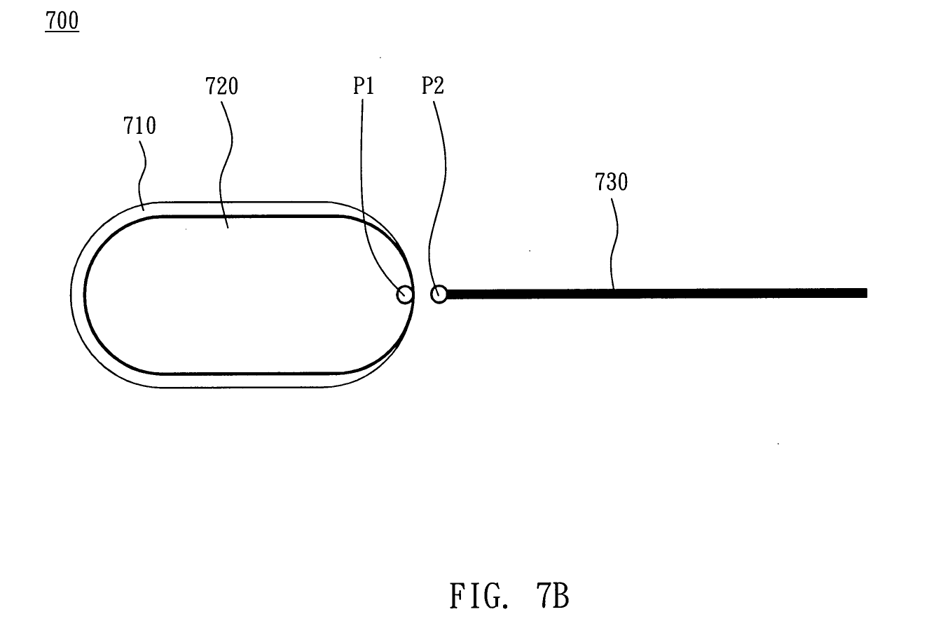

FIGS. 6A and 7B are two schematic illustrations showing dipole antennas according to other embodiments of the invention. As shown in FIGS. 6A and 7B, what is different from FIG. 1 is that the radiating metal plate 620 of the dipole antenna 600 in FIG. 6A has an octagonal shape, and the radiating metal plate 720 of the dipole antenna 700 in FIG. 7B substantially has an elliptic shape. Other structures and dimensional designs of the dipole antenna 600 in FIG. 6A may be the same as those of the dipole antenna 100 in FIG. 1 so that the dipole antenna 600 may have the impedance bandwidth and the radiation properties the same as those of the dipole antenna 100.

In summary, the radiating metal plate and the radiating metal line, which are made of different materials and have different dimensions, serve as two metal arms of the antenna in the dipole antenna of the invention. Thus, the system circuit and the radiating metal plate in the electronic apparatus, such as the digital television receiving apparatus or any other plug-and-play apparatus, may be integrated on the same substrate, and the radiating metal plate may serve as the ground plane of the system. In addition, the radiating metal line may be housed in the transmission cable of the electronic apparatus in a manner similar to that of the embodiment, or may be packaged and molded in conjunction with the industrial design. Consequently, the structure is simple and can easily be manufactured, and the dimension and the cost of the electronic apparatus are decreased. Meanwhile, the properties of the good impedance bandwidth and the good radiation efficiency may be kept. Thus, the dipole antenna and the electronic apparatus of the invention have the high value in the industrial applications.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dipole antenna, comprising:
a substrate;
a radiating metal plate, which is disposed on the substrate and has a first signal feeding point near a lateral side of the substrate; and
a radiating metal line having a second signal feeding point, which is near the first signal feeding point.

2. The antenna according to claim 1, wherein the radiating metal plate is formed on the substrate by way of etching or printing.

3. The antenna according to claim 1, wherein the radiating metal plate and the radiating metal line are made of different materials.

4. The antenna according to claim 1, wherein the radiating metal plate substantially has a polygonal shape or an elliptic shape.

5. The antenna according to claim 4, wherein the radiating metal plate has a rectangular shape, a width of 45 mm and a length of 95 mm.

6. The antenna according to claim 1, wherein a gap between the first signal feeding point and the second signal feeding point is substantially smaller than 3 mm.

7. The antenna according to claim 1, wherein the radiating metal line has a single core or multiple cores.

8. The antenna according to claim 1, wherein a length of the radiating metal line is about 135 mm.

9. An electronic apparatus, comprising:
a casing;
a dipole antenna, which comprises:
a substrate disposed in the casing;
a radiating metal plate, which is disposed in the substrate and has a first signal feeding point near a lateral side of the substrate; and
a radiating metal line having a second signal feeding point near the first signal feeding point; and
a control circuit, which is disposed in the casing and coupled to the dipole antenna.

10. The apparatus according to claim 9, wherein the control circuit is disposed on the substrate.

11. The apparatus according to claim 9 being a digital television receiving apparatus, wherein the control circuit comprises a digital television tuner electrically connected to the first signal feeding point and the second signal feeding point.

12. The apparatus according to claim 9, wherein the radiating metal plate is a ground plane of the electronic apparatus.

13. The apparatus according to claim 9, wherein the radiating metal plate and the radiating metal line are made of different materials.

14. The apparatus according to claim 9, wherein the radiating metal plate substantially has a polygonal shape or an elliptic shape.

15. The apparatus according to claim 9, wherein a gap between the first signal feeding point and the second signal feeding point is substantially smaller than 3 mm.

16. The apparatus according to claim 9, wherein the radiating metal line has a single core or multiple cores.

17. The apparatus according to claim 9, further comprising:
a transmission interface disposed in the casing; and
a transmission cable coupled to the casing.

18. The apparatus according to claim 20, wherein the radiating metal line is disposed in the transmission cable.

19. The apparatus according to claim 20, wherein the transmission interface is disposed on the substrate.

20. The apparatus according to claim 20, wherein the transmission interface is a universal serial bus interface.
